(19) United States
(12) Patent Application Publication
(10) Pub. No.: US 2025/0163600 A1
(43) Pub. Date: May 22, 2025

(54) ALPHA-Al203 PHASE ANODIC ALUMINUM OXIDE AND PREPARATION METHOD THEREFOR

(71) Applicant: INDUSTRY-UNIVERSITY COOPERATION FOUNDATION HANYANG UNIVERSITY ERICA CAMPUS, Ansan-si (KR)

(72) Inventors: Yong Ho CHOA, Seongnam-si (KR); Jae Ho YI, Ansan-si (KR); Ji Young PARK, Ansan-si (KR); Hai Shan SHEN, Ansan-si (KR)

(21) Appl. No.: 19/035,407

(22) Filed: Jan. 23, 2025

Related U.S. Application Data
(63) Continuation of application No. PCT/KR2023/013317, filed on Sep. 6, 2023.

(30) Foreign Application Priority Data
Sep. 6, 2022 (KR) 10-2022-0112477

(51) Int. Cl. C25D 11/10; C25D 11/18

(52) U.S. Cl. CPC C25D 11/10; C25D 11/18

(57) ABSTRACT

An anodic aluminum oxide preparation method comprises the steps of: anodizing aluminum in an electrolyte containing oxalic acid, thereby preparing anodic aluminum oxide having upper pores; applying a water-repellent coating to the upper pores of the anodic aluminum oxide; etching the lower part of the anodic aluminum oxide having the upper pores to which the water-repellent coating has been applied, thereby forming lower pores; immersing the anodic aluminum oxide in a pore-widening solution, thereby widening the diameter of the lower pores such that the diameter of the lower pores becomes equal to the diameter of the upper pores; and heat-treating the anodic aluminum oxide in which the upper pores and the lower pores have the same diameter.

### CROSS-REFERENCE TO RELATED APPLICATION

This application is a bypass continuation of pending PCT International Application No. PCT/KR2023/013317, which was filed on Sep. 6, 2023, and which claims priority to and the benefit of Korean Patent Application No. 10-2022-0112477, which was filed in the Korean Intellectual Property Office on Sep. 6, 2022, the disclosure of which is incorporated herein by reference in its entirety.

### TECHNICAL FIELD

The present invention relates to an α-Al₂O₃ phase anodic aluminum oxide and a preparation method therefor.

### BACKGROUND ART

Recently, with the high integration of semiconductors, the importance of a probe card for testing the performance of a semiconductor in post-semiconductor processes is being increased. Accordingly, there is a need to improve an integration rate of the probe of the probe card. In response to this demand, recently, research has been conducted to solve a manufacturing yield of a probe card and high integration of a probe pad by forming a ceramic substrate using an anodic aluminum oxide.

However, since the ceramic substrate is formed of an amorphous porous anodic aluminum oxide, the ceramic substrate has low characteristics such as hardness and chemical resistance. In addition, a low permittivity is required to solve an electrical problem occurring between metal wirings on the stacked ceramic substrate. To solve this problem, there has been an attempt to heat-treat the porous anodic aluminum oxide, but due to a difference in stress between upper and lower parts of the porous anodic aluminum oxide, problems such as cracking and bending have occurred.

### DISCLOSURE

### Technical Problem

One technical problem to be solved by the present invention is to provide an α-Al₂O₃ phase anodic aluminum oxide and a preparation method therefor.

Another technical problem to be solved by the present invention is to provide an anodic aluminum oxide having significantly reduced cracking and bending during heat treatment, and a preparation method therefor.

Still another technical problem to be solved by the present invention is to provide an anodic aluminum oxide with an improved thermal conductivity and a preparation method therefor.

Still another technical problem to be solved by the present invention is to provide an anodic aluminum oxide with improved hardness and a preparation method therefor.

Still another technical problem to be solved by the present invention is to provide an anodic aluminum oxide with improved chemical resistance.

Still another technical problem to be solved by the present invention is to provide an anodic aluminum oxide with a reduced permittivity and a preparation method therefor.

The technical problems to be solved by the present invention are not limited to those described above.

### Technical Solution

To solve the above technical problems, the present invention provides a preparation method for an anodic aluminum oxide.

According to one embodiment, the preparation method for an anodic aluminum oxide may include: anodizing aluminum in an electrolyte including oxalic acid to prepare anodic aluminum oxide having upper pores; applying a water-repellent coating to the upper pores of the anodic aluminum oxide; etching a lower part of the anodic aluminum oxide having the upper pores to which the water-repellent coating has been applied to form lower pores; immersing the anodic aluminum oxide in a pore-widening solution to widen a diameter of the lower pores such that the diameter of the lower pores is equal to a diameter of the upper pores; and heat-treating the anodic aluminum oxide in which the upper pores and the lower pores have the same diameter.

According to one embodiment, as the anodic aluminum oxide is heat-treated, a phase of the anodic aluminum oxide may be changed from amorphous Al₂O₃ to α-Al₂O₃.

According to one embodiment, a crack occurrence rate of the anodic aluminum oxide may be reduced due to the same diameter of the upper pores and the lower pores during the heat treatment of the anodic aluminum oxide.

According to one embodiment, in the widening of the diameter of the lower pores, the diameter of the upper pores may be maintained by the water-repellent coating.

According to one embodiment, a concentration and a temperature of the pore-widening solution may be controlled to reduce a difference in the diameter between the upper pores and the lower pores.

According to one embodiment, the concentration of the pore-widening solution may be controlled to be greater than 5 wt % and less than 15 wt %, thereby reducing the difference in the diameter between the upper pores and the lower pores.

According to one embodiment, the temperature of the pore-widening solution may be controlled to be higher than 25° C. and lower than 40° C., thereby reducing the difference in the diameter between the upper pores and the lower pores.

According to one embodiment, the anodic aluminum oxide may be heat-treated at a temperature exceeding 850° C.

According to one embodiment, the pore-widening solution may include a phosphoric acid solution.

According to one embodiment, as the anodic aluminum oxide is heat-treated, a thermal conductivity and a hardness are improved, and a permittivity is reduced.

To solve the above technical problems, the present invention provides an anodic aluminum oxide.

According to one embodiment, the anodic aluminum oxide may have hollows for allowing upper pores and lower pores to communicate with each other, in which the anodic aluminum oxide may include the upper pores and the lower pores that have the same diameter, and may have an α-Al₂O₃ phase.

According to one embodiment, the anodic aluminum oxide may have a Vickers hardness of 800 GPa or greater.

According to one embodiment, the anodic aluminum oxide may have a thermal conductivity of 13.7 W/m·K or greater.

According to one embodiment, the anodic aluminum oxide may be applied to any one of a semiconductor probe card, a photonic structure, a sensor, a template, a membrane, a drug delivery substrate, and a composite functional layer.

### Advantageous Effects

According to the embodiment of the present invention, the preparation method for an anodic aluminum oxide may include: anodizing aluminum in an electrolyte including oxalic acid to prepare anodic aluminum oxide having upper pores; applying a water-repellent coating to the upper pores of the anodic aluminum oxide; etching a lower part of the anodic aluminum oxide having the upper pores to which the water-repellent coating has been applied to form lower pores; immersing the anodic aluminum oxide in a pore-widening solution to widen a diameter of the lower pores such that the diameter of the lower pores is equal to a diameter of the upper pores; and heat-treating the anodic aluminum oxide in which the upper pores and the lower pores have the same diameter.

Accordingly, an α-Al₂O₃ phase anodic aluminum oxide having a high thermal conductivity of 13.7 W/m·K or greater and a high hardness of 8.00 GPa or greater may be prepared. Accordingly, the anodic aluminum oxide may be easily applied to a semiconductor probe card, a photonic structure, a sensor, a template, a membrane, a drug delivery substrate, a composite functional layer, and the like, which require high physical stability and chemical stability.

In addition, since the difference in stress between the upper and lower parts of the anodic aluminum oxide is significantly reduced, problems such as cracking and bending that occur during the heat treatment may be significantly reduced.

### DESCRIPTION OF DRAWINGS

FIG. 1 is a flowchart for explaining a preparation method for an anodic aluminum oxide according to an embodiment of the present invention.

FIG. 2 is a view for explaining step S100 of the preparation method for an anodic aluminum oxide according to the embodiment of the present invention.

FIG. 3 is a view for explaining step S300 of the preparation method for an anodic aluminum oxide according to the embodiment of the present invention.

FIG. 4 is a view for explaining step S400 of the preparation method for an anodic aluminum oxide according to the embodiment of the present invention.

FIG. 5 is a view showing XRD analysis results for confirming a phase of the anodic aluminum oxide according to an experimental example of the present invention.

FIG. 6 is a view for explaining an influence due to a difference in diameter between upper pores and lower pores during a preparation process of the anodic aluminum oxide according to the experimental example of the present invention.

FIG. 7 is an FE-SEM image of the anodic aluminum oxide according to the experimental example of the present invention.

FIG. 8 is a view for explaining a Vickers hardness of the anodic aluminum oxide according to the experimental example of the present invention.

FIG. 9 is a view for explaining material deformation of the anodic aluminum oxide due to an external physical force according to the experimental example of the present invention.

FIG. 10 is a view for explaining results of an experiment on chemical resistance of the anodic aluminum oxide in a base environment according to the experimental example of the present invention.

FIG. 11 is a view for explaining results of an experiment on chemical resistance of the anodic aluminum oxide in an acid environment according to the experimental example of the present invention.

FIG. 12 is a view for explaining results of measuring a dielectric constant of the anodic aluminum oxide according to the experimental example of the present invention.

FIG. 13 is a view for explaining an influence according to a type of an electrolyte used for anodization during the preparation process of the anodic aluminum oxide according to the experimental example of the present invention.

FIG. 14 is a view for explaining an influence according to a concentration of a pore-widening solution during the preparation process of the anodic aluminum oxide according to the experimental example of the present invention.

FIG. 15 is a view for explaining an influence according to a temperature of the pore-widening solution during the preparation process of the anodic aluminum oxide according to the experimental example of the present invention.

FIG. 16 is a view for explaining an influence according to an anodization voltage during the preparation process of the anodic aluminum oxide according to the experimental example of the present invention.

FIG. 17 is a view for explaining a change in weight according to a heat treatment temperature during the preparation process of the anodic aluminum oxide according to the experimental example of the present invention.

FIG. 18 is a view showing XRD analysis results for explaining a change in phase according to a heat treatment temperature during the preparation process of the anodic aluminum oxide according to the experimental example of the present invention.

FIG. 19 is a view for explaining a change in Vickers hardness according to a heat treatment temperature during the preparation process of the anodic aluminum oxide according to the experimental example of the present invention.

FIG. 20 is a view for explaining a change in state according to a heat treatment temperature during the preparation process of the anodic aluminum oxide according to the experimental example of the present invention.

FIG. 22 is a view for explaining a change in contamination layer according to a heat treatment temperature during the preparation process of the anodic aluminum oxide according to the experimental example of the present invention.

### MODE FOR INVENTION

Hereinafter, preferred embodiments of the present invention will be described in detail with reference to the accompanying drawings. However, the present invention may be embodied in different forms and should not be construed as limited to the embodiments set forth herein. Rather, the embodiments introduced herein are provided so that the disclosed contents may be thorough and complete and the spirit of the present invention may be sufficiently conveyed to those skilled in the art.

In the present specification, it will be understood that when an element is referred to as being “on” another element, it can be formed directly on the other element or intervening elements may be present. In the drawings, the thicknesses of layers and regions are exaggerated for clarity.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combination thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, when detailed descriptions of related known functions or constitutions are considered to unnecessarily cloud the gist of the present invention in describing the present invention below, the detailed descriptions will not be included.

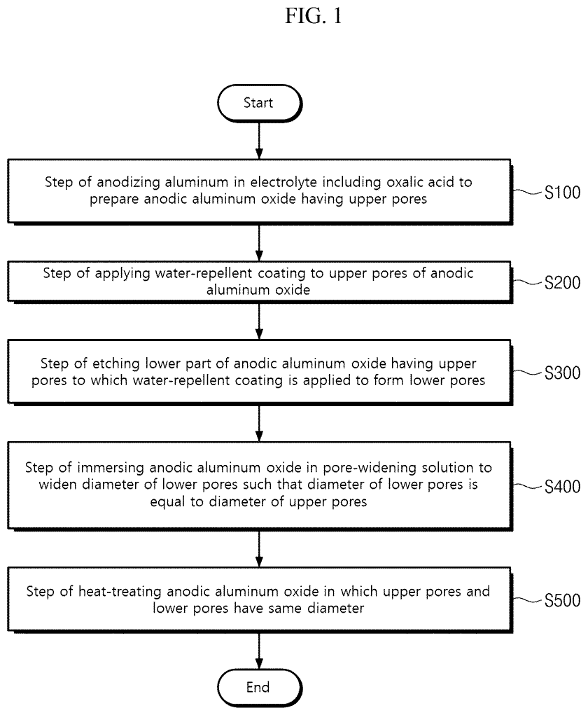

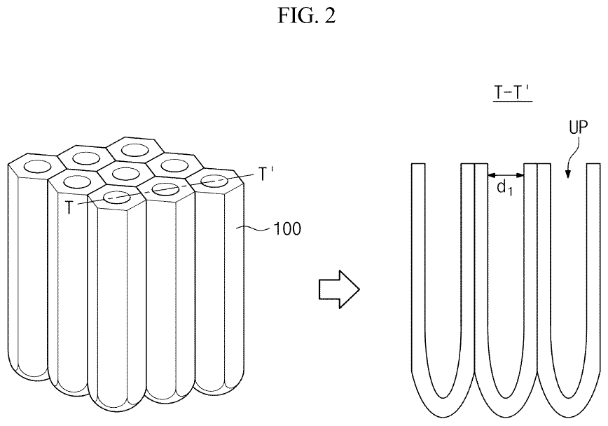

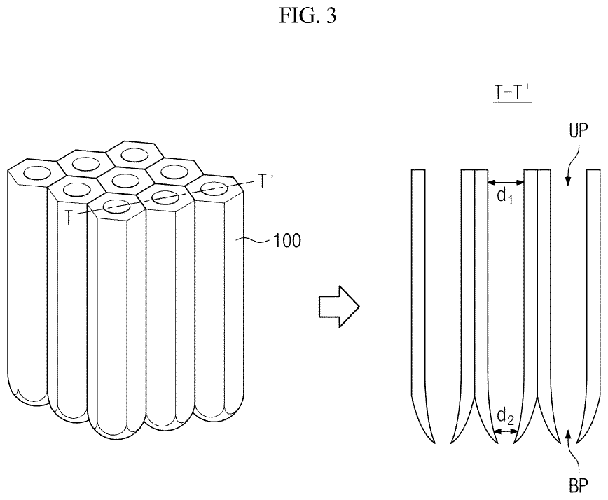

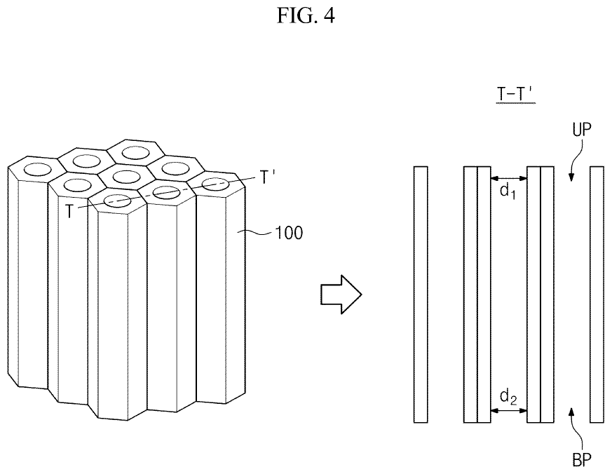

FIG. 1 is a flowchart for explaining a preparation method for an anodic aluminum oxide according to an embodiment of the present invention, FIG. 2 is a view for explaining step S100 of the preparation method for an anodic aluminum oxide according to the embodiment of the present invention, FIG. 3 is a view for explaining step S300 of the preparation method for an anodic aluminum oxide according to the embodiment of the present invention, and FIG. 4 is a view for explaining step S400 of the preparation method for an anodic aluminum oxide according to the embodiment of the present invention.

Referring to FIGS. 1 to 4, aluminum is anodized in an electrolyte including oxalic acid to prepare anodic aluminum oxide 100 having upper pores UP (S100). According to one embodiment, the step of preparing the anodic aluminum oxide 100 having the upper pores UP may include: a step S100 of preparing an aluminum foil; a step S120 of removing organic contaminants by performing ultrasonic treatment on the aluminum foil; a step S130 of electropolishing the aluminum foil from which the organic contaminants have been removed; a step S140 of primarily anodizing the electropolished aluminum foil in oxalic acid to form a porous anodic aluminum oxide 100 on the aluminum foil; a step of S150 wet-chemical etching the anodic aluminum oxide; a step of S160 secondarily anodizing the wet-chemical etched anodic aluminum oxide 100 in the oxalic acid; and a step S170 of separating the anodic aluminum oxide 100 from the aluminum foil.

More specifically, after a high-purity aluminum foil is prepared (S110), the organic contaminants may be removed by ultrasonic treatment in anhydrous acetone for 2 minutes (S120), and the aluminum foil may be electropolished for 120 seconds at 0° C. and 20 V in a mixture of perchloric acid and ethanol (1:4 volume %)(S130).

Thereafter, the primary anodization may be performed for 30 minutes in 0.3 M of oxalic acid at a temperature of 5° C. to 20° C. and 50 V (S140). As the primary anodization is performed, the porous anodic aluminum oxide 100 may be formed on the aluminum foil.

The anodic aluminum oxide 100 formed through the primary anodization may be wet-chemical etched with 1.8 wt/of chromic acid and 6 wt % of phosphoric acid at 60° C. for 2 hours (S150). Accordingly, irregular pores formed on a surface of the anodic aluminum oxide 100 prepared through the primary anodization may be removed.

The wet-chemical etched anodic aluminum oxide 100 may be secondarily anodized in 0.3 M of oxalic acid at a temperature of 5° C. to 20° C. and 55 V for 8 hours (S160). As the secondary anodization is performed, the anodic aluminum oxide 100 is grown and regular pores may be formed in the anodic aluminum oxide 100.

The secondarily anodic aluminum oxide 100 may be immersed in a mixture of 0.1 M of copper chloride and 20 vol % of hydrochloric acid (HCl) for 1 hour. Accordingly, the anodic aluminum oxide 100 may be separated from the aluminum foil by selectively removing the aluminum foil (S170). Therefore, the anodic aluminum oxide 100 having the upper pores UP may be prepared. According to one embodiment, the anodic aluminum oxide 100 prepared in step S100 may have a structure in which an upper region thereof has pores, but a lower region thereof has no pores, as shown in FIG. 2.

Unlike the above description, when a material other than oxalic acid (e.g., sulfuric acid, phosphoric acid, etc.) is used as the electrolyte for preparing the anodic aluminum oxide 100, uniformity of the pores may be reduced. Accordingly, during the heat treatment of the anodic aluminum oxide in step S500 to be described later, cracks may be formed in the anodic aluminum oxide, or a thermal conductivity and a hardness of the heat-treated anodic aluminum oxide may be reduced.

After the anodic aluminum oxide 100 having the upper pores UP is prepared, a water-repellent coating may be applied to the upper pores UP of the anodic aluminum oxide 100 (S200). According to one embodiment, the upper pores UP may be applied with the water-repellent coating by using a micro stopper. For example, a sfront-off lacquer (Miccrosfron, Tolber, USA) may be used as the micro stopper.

A lower part of the anodized aluminum oxide 100 having the upper pores UP to which the water-repellent coating is applied may be etched to form lower pores BP (S300). According to one embodiment, the lower pores BP may be formed in the lower part of the anodic aluminum oxide 100 by immersing the lower part of the anodic aluminum oxide 100 having the upper pores UP to which the water-repellent coating is applied in a mixture of 0.1 M of copper chloride and 20 vol % of hydrochloric acid (HCI). A diameter d₂ of the lower pores BP formed in step S300 may be smaller than a diameter d₁ of the upper pores UP.

The anodic aluminum oxide 100 in which the upper pores UP and the lower pores BP are formed may be immersed in a pore-widening solution. Accordingly, the diameter d₂ of the lower pores BP may be widened such that the diameter d₂ of the lower pores BP is equal to the diameter d₁ of the upper pores UP (S400). That is, the diameter d₂ of the lower pores BP may be widened through the pore-widening solution. In this case, since the upper pores UP are applied with the water-repellent coating through the micro stopper, the upper pores UP may not react with the pore-widening solution, thereby maintaining the diameter d₁. According to one embodiment, a phosphoric acid solution may be used as the pore-widening solution.

According to one embodiment, a concentration and a temperature of the pore-widening solution may be controlled to reduce the difference between the diameter d₁ of the upper pores UP and the diameter d₂ of the lower pores BP. Specifically, the concentration of the pore-widening solution may be controlled to be greater than 5 wt % and less than 15 wt %, thereby reducing the difference between the diameter d₁ of the upper pores UP and the diameter d₂ of the lower pores BP. In addition, the temperature of the pore-widening solution may be controlled to be higher than 25° C. and lower than 40° C., thereby reducing the difference between the diameter d₁ of the upper pores UP and the diameter d₂ of the lower pores BP.

That is, the diameter d₁ of the upper pores UP and the diameter d₂ of the lower pores BP may be the same under a condition in which the concentration of the pore-widening solution is controlled to be greater than 5 wt % and less than 15 wt % or a condition in which the temperature of the pore-widening solution is controlled to be higher than 25° C. and lower than 40° C. In contrast, when the concentration of the pore-widening solution is controlled to be equal to or less than 5 wt % or equal to or greater than 15 wt %, or the temperature of the pore-widening solution is controlled to be equal to or lower than 25° C. or equal to or less than 4° C., there may be a problem in a large difference between the diameter d₁ of the upper pores UP and the diameter d₂ of the lower pores BP.

The anodic aluminum oxide 100 in which the diameter d₁ of the upper pores UP and the diameter d₂ of the lower pores BP are the same may be heat-treated (S500). Unlike the above description, when the anodic aluminum oxide 100 is heat-treated in a state where the diameter d₁ of the upper pores UP and the diameter d₂ of the lower pores BP are different from each other, problems such as cracking and bending may occur due to a difference in stress between the upper and lower parts of the anodic aluminum oxide 100. On the other hand, when the anodic aluminum oxide 100 is heat-treated in a state where the diameter d₁ of the upper pores UP and the diameter d₂ of the lower pores BP are the same, a difference in stress between the upper and lower parts is reduced, and thus problems such as cracking and bending occurring during the heat treatment may be significantly reduced.

As the anodic aluminum oxide 100 is heat-treated, the anodic aluminum oxide 100 may be changed from an amorphous Al₂O₃ phase to an α-Al₂O₃ phase. The anodic aluminum oxide 100 having the α-Al₂O₃ phase may have improved thermal conductivity and hardness, and a reduced permittivity as compared to the anodic aluminum oxide 100 having the amorphous Al₂O₃ phase. For example, the heat-treated anodic aluminum oxide 100 may have a high thermal conductivity of 13.7 W/m·K or greater and a high hardness of 8.00 GPa or greater.

According to one embodiment, the anodic aluminum oxide 100 may be heat-treated at a temperature exceeding 850° C. For example, the anodic aluminum oxide 100 may be heat-treated at a temperature of 1300° C. Accordingly, the anodic aluminum oxide 100 may be changed from the amorphous Al₂O₃ phase to the α-Al₂O₃ phase. On the other hand, when the anodic aluminum oxide 100 is heat-treated at a temperature of 850° C., the anodic aluminum oxide 100 is changed to a γ-Al₂O₃ phase or a δ-Al₂O₃ phase, not the α-Al₂O₃ phase, so that the thermal conductivity and the hardness may be relatively reduced and the permittivity may be increased as compared to the α-Al₂O₃ phase.

As a result, the preparation method for an anodic aluminum oxide according to the embodiment of the present invention may include: the step S100 of anodizing aluminum in an electrolyte including oxalic acid to prepare anodic aluminum oxide having upper pores; the step S200 of applying a water-repellent coating to the upper pores of the anodic aluminum oxide; the step S300 of etching a lower part of the anodic aluminum oxide having the upper pores to which the water-repellent coating has been applied to form lower pores; the step S400 of immersing the anodic aluminum oxide in a pore-widening solution to widen a diameter of the lower pores such that the diameter of the lower pores is equal to a diameter of the upper pores; and the step S500 of heat-treating the anodic aluminum oxide in which the upper pores and the lower pores have the same diameter.

Accordingly, an α-Al₂O₃ phase anodic aluminum oxide having a high thermal conductivity of 13.7 W/m·K or greater and a high hardness of 8.00 GPa or greater may be prepared. Accordingly, the anodic aluminum oxide may be easily applied to a semiconductor probe card, a photonic structure, a sensor, a template, a membrane, a drug delivery substrate, a composite functional layer, and the like, which require high physical stability and chemical stability.

In addition, since the difference in stress between the upper and lower parts of the anodic aluminum oxide is significantly reduced, problems such as cracking and bending that occur during the heat treatment may be significantly reduced.

Hereinabove, the anodic aluminum oxide and the preparation method therefor according to the embodiment of the present invention has been described. Hereinafter, specific experimental examples and characteristic evaluation results of the anodic aluminum oxide and the preparation method therefor according to the embodiment of the present invention will be described.

### Preparation of Anodic Aluminum Oxide According to Experimental Example

After a high-purity aluminum foil was prepared, the organic contaminants were removed by ultrasonic treatment in anhydrous acetone for 2 minutes, and the aluminum foil was electropolished for 120 seconds at 0° C. and 20 V in a mixture of perchloric acid and ethanol (1:4 volume %).

Thereafter, primary anodization was performed for 30 minutes in 0.3 M of oxalic acid at a temperature of 5° C. to 20° C. and 50 V to form a porous anodic aluminum oxide on the aluminum foil.

The anodic aluminum oxide formed through the primary anodization was wet-chemical etched with 1.8 wt % of chromic acid and 6 wt % of phosphoric acid at 60° C. for 2 hours to remove irregular pores formed on a surface of the anodic aluminum oxide.

The wet-chemical etched anodic aluminum oxide was secondarily anodized in 0.3 M of oxalic acid at a temperature of 5° C. to 20° C. and 55 V for 8 hours to grow the anodic aluminum oxide.

The secondarily anodized aluminum oxide was immersed in a mixture of 0.1 M of copper chloride and 20 vol % of hydrochloric acid (HCl) for 1 hour to selectively remove the aluminum foil, thereby preparing the anodic aluminum oxide having upper pores. The upper pores were applied with a water-repellent coating by using a sfront-off lacquer (Miccrosfron, Tolber, USA).

A lower part of the anodic aluminum oxide was immersed in the mixture of 0.1 M of copper chloride and 20 vol % of hydrochloric acid (HCl) to form lower pores. The anodic aluminum oxide having the lower pores was immersed in a pore-widening solution to widen a diameter of the lower pores such that the diameter of the lower pores was equal to a diameter of the upper pores. As the pore-widening solution, a phosphoric acid solution was used. Finally, the anodic aluminum oxide, in which the diameters of the upper and lower pores were the same, was heat-treated to prepare an anodic aluminum oxide according to an experimental example.

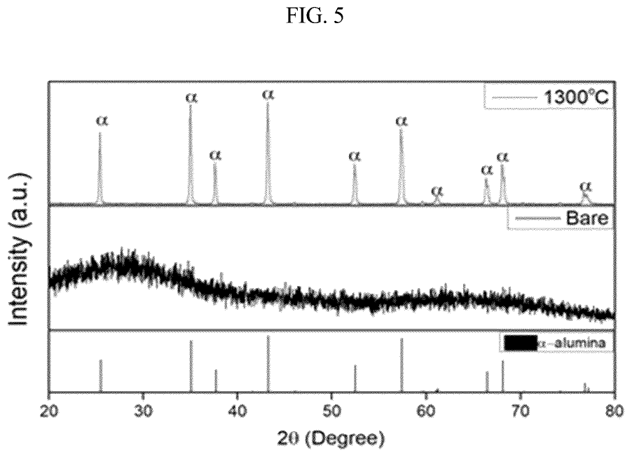

FIG. 5 is a view showing XRD analysis results for confirming a phase of the anodic aluminum oxide according to an experimental example of the present invention.

Referring to FIG. 5, it shows X-ray diffraction (XRD) analysis results for the anodic aluminum oxide according to the experimental example, which was prepared by heat treatment at a temperature of 1300° C., and an anodic aluminum oxide (Bare) before heat treatment.

As can be seen from FIG. 5, it was confirmed that the anodic aluminum (Bare) before heat treatment has an amorphous-Al₂O₃ phase, whereas the anodic aluminum oxide according to the experimental example, which is prepared by heat treatment at a temperature of 1300° C., has an α-Al₂O₃ phase.

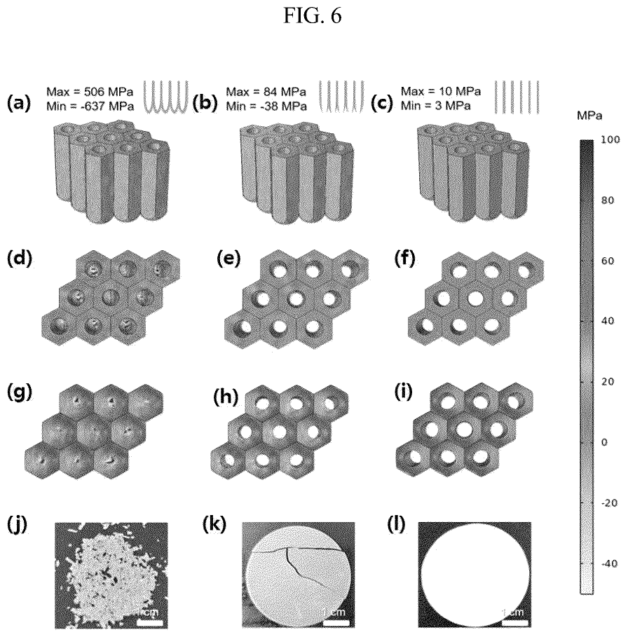

FIG. 6 is a view for explaining an influence due to a difference in diameter between upper pores and lower pores during a preparation process of the anodic aluminum oxide according to the experimental example of the present invention.

Referring to FIG. 6, it shows a change in stress of the anodic aluminum oxide, which is generated during heat treatment, according to the difference in diameter between the upper pores and the lower pores through comsol simulation. Specifically, (a), (d), and (g) of FIG. 6 show the change in stress generated when an anodic aluminum oxide, in which the upper pores have a diameter of 75 nm and the lower pores have a diameter of 0 nm, is heat-treated from room temperature to 1300° C. at a temperature increase rate of 5° C./min through 3D modeling. On the other hand, (b), (e), and (h) of FIG. 6 show the change in stress generated when an anodic aluminum oxide, in which the upper pores have a diameter of 75 nm and the lower pores have a diameter of 45 nm, is heat-treated from room temperature to 1300° C. at a temperature increase rate of 5° C./min through 3D modeling. On the other hand, (c), (f), and (i) of FIG. 6 show the change in stress generated when an anodic aluminum oxide, in which the upper pores have a diameter of 75 nm and the lower pores have a diameter of 75 nm, is heat-treated from room temperature to 1300° C. at a temperature increase rate of 5° C./min through 3D modeling.

(j) of FIG. 6 is a photograph of a state where the anodic aluminum oxide, in which the upper pores have a diameter of 75 nm and the lower pores have a diameter of 0 nm, is heat-treated, (k) of FIG. 6 a photograph of a state where the anodic aluminum oxide, in which the upper pores have a diameter of 75 nm and the lower pores have a diameter of 45 nm, is heat-treated, and (l) of FIG. 6 is a photograph of a state where the anodized aluminum oxide, in which the upper pores have a diameter of 75 nm and the lower pores have a diameter of 75 nm, is heat-treated.

TABLE 1

| | Upper pore | Lower pore |
|---|---|---|
| Classification | diameter | diameter |
| (a), (d), (g), and (j) of FIG. 6 | 75 nm | 0 nm |
| (b), (e), (h), and (k) of FIG. 6 | 75 nm | 45 nm |
| (c), (f), (i), and (1) of FIG. 6 | 75 nm | 75 nm |

As can be seen from (a), (d), and (g) of FIG. 6, it was confirmed that when the anodic aluminum oxide, in which the upper pores have a diameter of 75 nm and the lower pores have a diameter of 0 nm, is heat-treated, a compressive force is concentrated on a central part of the lower pores, and a tensile force is evenly distributed in the anodized aluminum oxide. In addition, it was confirmed that the stress shows a maximum compressive force of 506 MPa and a tensile force of 637 MPa.

As can be seen from (b), (e), and (h) of FIG. 6, it was confirmed that when the anodic aluminum oxide, in which the upper pores have a diameter of 75 nm and the lower pores have a diameter of 45 nm, is heat-treated, a compressive force is concentrated on a boundary portion of the lower pores, and a tensile force is evenly distributed in the anodized aluminum oxide. In addition, it was confirmed that the stress shows the maximum compressive force of 84 MPa and the tensile force of 38 MPa.

As can be seen from (c), (f), and (i) of FIG. 6, it was confirmed that when the anodic aluminum oxide, in which the upper pores have a diameter of 75 nm and the lower pores have a diameter of 75 nm, is heat-treated, there is no stress concentration and the maximum compressive force of 10 MPa and the tensile force of 3 MPa are shown.

As can be seen from (j) and (k) of FIG. 6, it was confirmed that cracks are generated and a cracking phenomenon occurs when the anodic aluminum oxide is heat-treated in a state where the upper pores and the lower pores have different diameters. On the other hand, as can be seen from (l) of FIG. 6, it was confirmed that cracks are not generated and a cracking phenomenon does not occur when the anodic aluminum oxide is heat-treated in a state where the upper pores and the lower pores have the same diameter.

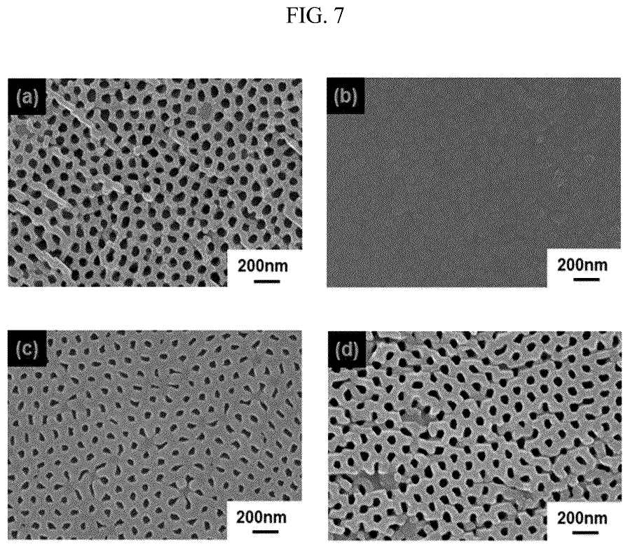

FIG. 7 is an FE-SEM image of the anodic aluminum oxide according to the experimental example of the present invention.

Referring to (a) of FIG. 7, it shows a field emission scanning electron microscope (FE-SEM) image for upper pores having a diameter of 75 nm, referring to (b) of FIG. 7, it shows an FE-SEM image for lower pores having a diameter of 0 nm, referring to (c) of FIG. 7, it shows an FE-SEM image for lower pores having a diameter of 45 nm, and referring to (d) of FIG. 7, it shows an FE-SEM image for lower pores having a diameter of 75 nm.

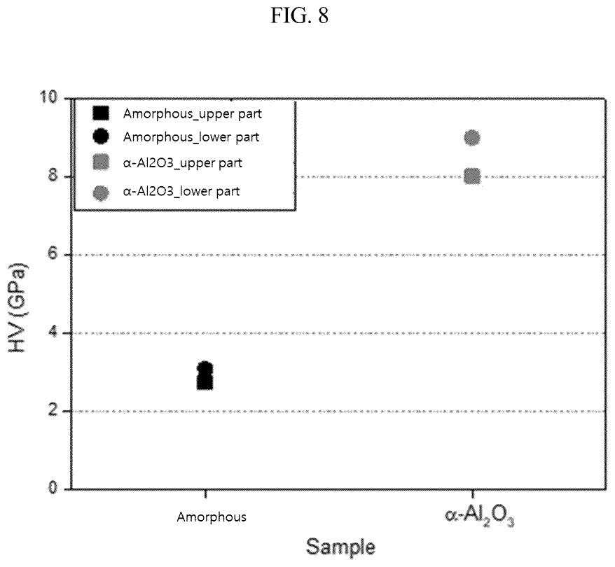

FIG. 8 is a view for explaining a Vickers hardness of the anodic aluminum oxide according to the experimental example of the present invention.

Referring to FIG. 8, a Vickers hardness (HV, GPa) of upper and lower parts of an anodic aluminum oxide (amorphous) before heat treatment and a Vickers hardness (HV, GPa) of upper and lower parts of an anodic aluminum oxide (α-Al₂O₃) that has been heat-treated are measured and shown.

As can be seen from FIG. 8, it was confirmed that the upper part of the anodic aluminum oxide (amorphous) before heat treatment has a Vickers hardness of 2.74 GPa and the lower part thereof has a Vickers hardness of 3.08 GPa. On the other hand, it was confirmed that the upper part of the anodic aluminum oxide (α-Al₂O₃) that has been heat-treated has a Vickers hardness of 8.00 GPa and the lower part thereof has a Vickers hardness of 8.98 GPa.

That is, it was confirmed that as the anodic aluminum oxide according to the experimental example of the present invention is changed from an amorphous-Al₂O₃ phase to an α-Al₂O₃ phase by heat treatment, the Vickers hardness is significantly improved (about 3 times improved).

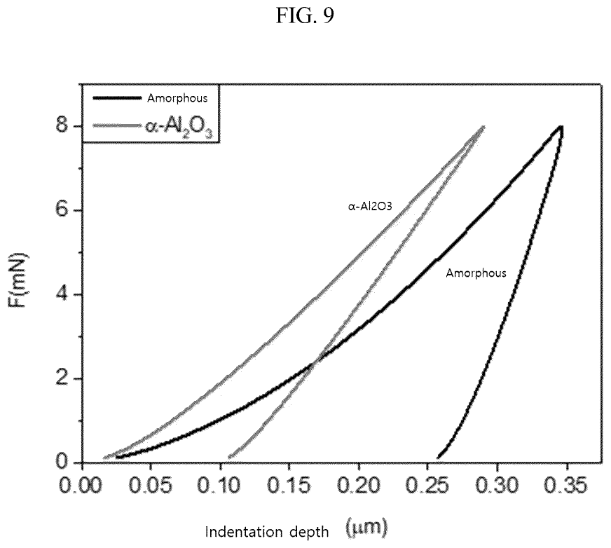

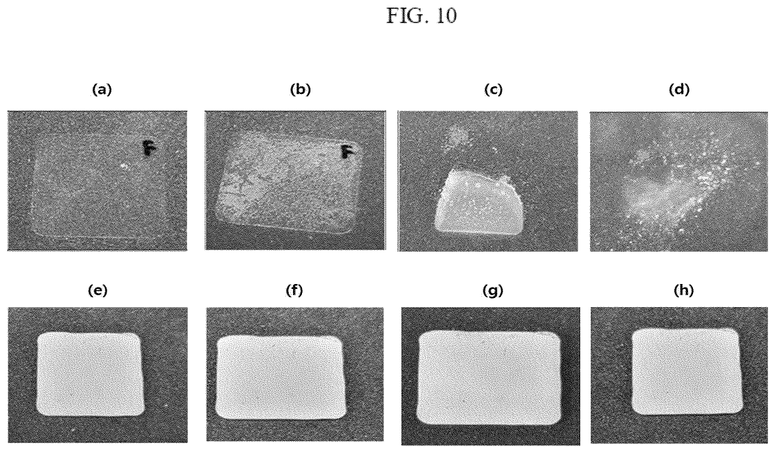

FIG. 9 is a view for explaining material deformation of the anodic aluminum oxide due to an external physical force according to the experimental example of the present invention.

Referring to FIG. 9, it shows results of performing a nanoindenter test on each of the anodic aluminum oxide (amorphous) before heat treatment and the anodic aluminum oxide (α-Al₂O₃) that has been heat-treated. Specifically, the nanoindenter test was performed by indentation for 8 seconds under a load of 8 mN.

As can be seen from FIG. 9, it was confirmed that anodic aluminum oxide (amorphous) before heat treatment shows an indentation depth of up to 347 nm, and the anodic aluminum oxide (α-Al₂O₃) that has been heat-treated shows an indentation depth of up to 289 nm. That is, it was found that as the anodic aluminum oxide according to the experimental example of the present invention is changed from an amorphous-Al₂O₃ phase to an α-Al₂O₃ phase by heat treatment, less material deformation occurs due to an external physical force.

In addition, an indentation hardness and a Martens hardness were measured for each of the anodic aluminum oxide (amorphous) before heat treatment and the anodic aluminum oxide (α-Al₂O₃) that has been heat-treated, and the measurement results are summarized through the following <Table 2>.

TABLE 2

| Classification | Amorphous-Al₂O₃ | α-A1₂O₃ |
|---|---|---|
| Indentation hardness (GPa) | 6.24 | 13.73 |
| Martens hardness (GPa) | 4.14 | 7.47 |

FIG. 10 is a view for explaining results of an experiment on chemical resistance of the anodic aluminum oxide in a base environment according to the experimental example of the present invention.

Referring to FIG. 10, it shows an experiment on chemical resistance for a base environment, which is performed by providing a sodium hydroxide solution having a concentration of 10 wt % to each of the anodic aluminum oxide (amorphous) before heat treatment and the anodic aluminum oxide (α-Al₂O₃) that has been heat-treated. Specifically, (a) to (d) of FIG. 10 show results of the experiment on the anodic aluminum oxide (amorphous) before heat treatment, and (e) and (f) of FIG. 10 show results of the experiment on the anodic aluminum oxide (α-Al₂O₃) that has been heat-treated. In addition, (a) and (e) of FIG. 10 show an initial state before the sodium hydroxide solution is provided, (b) and (f) of FIG. 10 show a state of 10 minutes after the sodium hydroxide solution is provided, (c) and (g) of FIG. 10 show a state of 20 minutes after the sodium hydroxide solution is provided, and (d) and (h) of FIG. 10 show a state of 30 minutes after the sodium hydroxide solution is provided.

As can be seen from (a) to (d) of FIG. 10, it was confirmed that the anodic aluminum (amorphous) before heat treatment is dissolved by reacting with the sodium hydroxide solution, whereas as can be seen from (e) to (h) of FIG. 10, it was confirmed that the anodic aluminum (α-Al₂O₃) that has been heat-treated maintains its initial state without reacting with the sodium hydroxide solution.

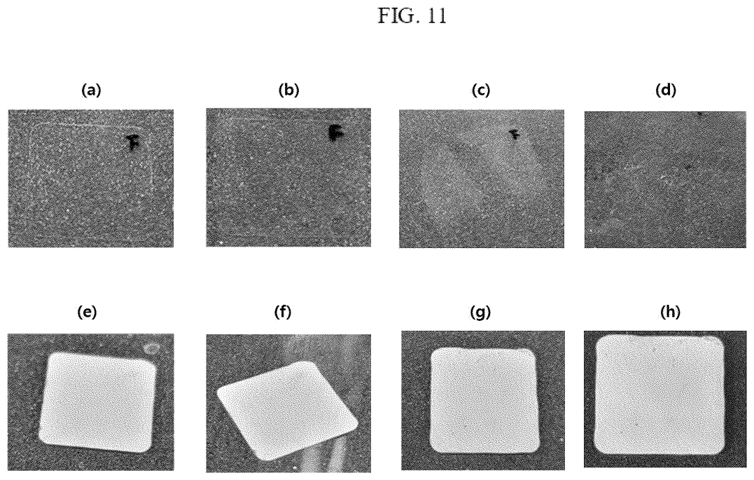

FIG. 11 is a view for explaining results of an experiment on chemical resistance of the anodic aluminum oxide in an acid environment according to the experimental example of the present invention.

Referring to FIG. 11, it shows an experiment on chemical resistance for an acid environment, which is performed by providing a sulfuric acid solution having a concentration of 1 M to each of the anodic aluminum oxide (amorphous) before heat treatment and the anodic aluminum oxide (α-Al₂O₃) that has been heat-treated. Specifically, (a) to (d) of FIG. 11 show results of the experiment on the anodic aluminum oxide (amorphous) before heat treatment, and (e) and (f) of FIG. 11 show results of the experiment on the anodic aluminum oxide (α-Al₂O₃) that has been heat-treated. In addition, (a) and (e) of FIG. 11 show an initial state before the sulfuric acid solution is provided, (b) and (f) of FIG. 11 show a state of 1 hour after the sulfuric acid solution is provided, (c) and (g) of FIG. 11 show a state of 2 hour after the sulfuric acid solution is provided, and (d) and (h) of FIG. 11 show a state of 3 hour after the sulfuric acid solution is provided.

As can be seen from (a) to (d) of FIG. 11, it was confirmed that the anodic aluminum (amorphous) before heat treatment is dissolved by reacting with the sulfuric acid solution, whereas as can be seen from (e) to (h) of FIG. 11, it was confirmed that the anodic aluminum (α-Al₂O₃) that has been heat-treated maintains its initial state without reacting with the sulfuric acid solution.

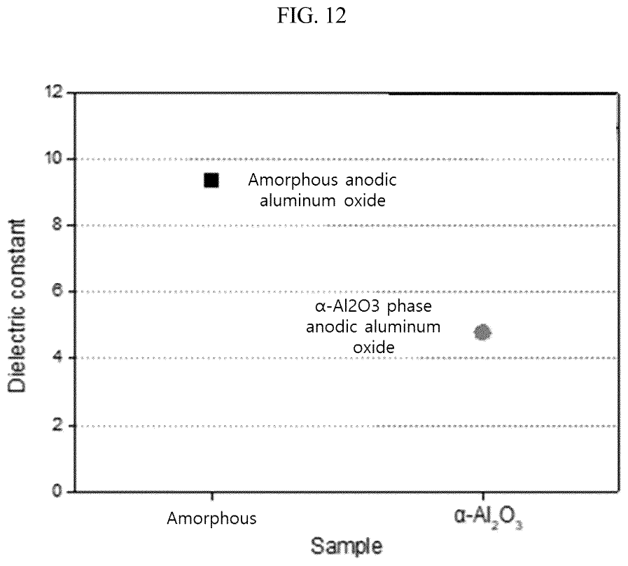

FIG. 12 is a view for explaining results of measuring a dielectric constant of the anodic aluminum oxide according to the experimental example of the present invention.

Referring to FIG. 12, it shows results of measuring a dielectric constant at a frequency of 1 MHz for each of the anodic aluminum oxide (amorphous) before heat treatment and the anodic aluminum oxide (α-Al₂O₃) that has been heat-treated. Specifically, the dielectric constant was calculated by forming a gold electrode having an area (1 cm×1 cm) on the upper and lower parts of the anodic aluminum oxide using a sputter, extending the electrode using a copper wire, and measuring capacitance using an LCR meter. The equation used for measuring the dielectric constant is shown in the following <Equation 1>.

$$Dielectric Constant = \frac{( Capacitance ) ( Vertical Distance Between Electrodes )}{( Area of Electrode ) ( Space Permittivity )} \qquad < Equation 1 >$$

(Space permittivity: 8.854×10⁻¹² F/m, Vertical distance between amorphous-Al₂O₃ anodic aluminum oxide electrodes: 99 μm, Capacitance of amorphous-Al₂O₃ anodic aluminum oxide: 8.38×10⁻¹¹ F, Vertical distance between α-Al₂O₃ anodic aluminum oxide electrodes: 101 μm, α-Al₂O₃ Capacitance of anodic aluminum oxide: 4.20×10⁻¹¹ F)

As a result of measuring the dielectric constant, the anodic aluminum oxide (amorphous) before heat treatment showed a dielectric constant of 9.37, and the anodic aluminum oxide (α-Al₂O₃) that has been heat-treated showed a dielectric constant of 4.79. That is, it was confirmed that as the anodic aluminum oxide according to the experimental example of the present invention is changed from an amorphous-Al₂O₃ phase to an α-Al₂O₃ phase by heat treatment, the permittivity is reduced.

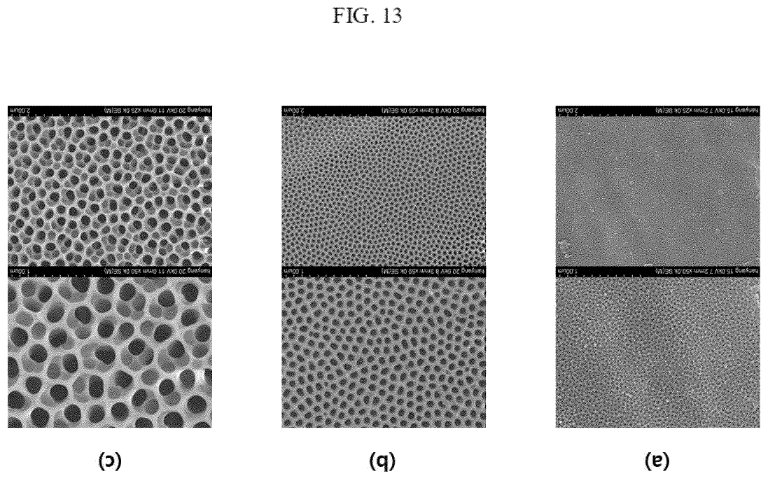

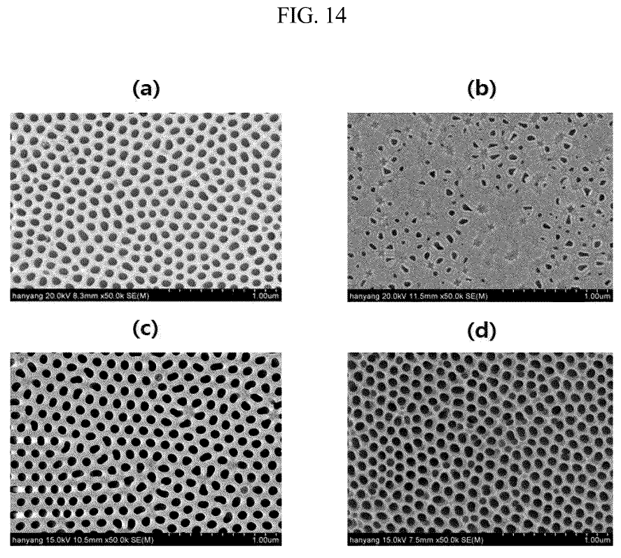

FIG. 13 is a view for explaining an influence according to a type of an electrolyte used for anodization during the preparation process of the anodic aluminum oxide according to the experimental example of the present invention.

Referring to FIG. 13, it shows an SEM image for each of the anodic aluminum oxides prepared through different types of electrolytes. Specifically, (a) of FIG. 13 shows an SEM image for an anodic aluminum oxide prepared through 0.3 M of sulfuric acid, (b) of FIG. 13 shows an SEM image for an anodic aluminum oxide prepared through 0.3 M of oxalic acid, and (c) of FIG. 13 shows an SEM image for an anodic aluminum oxide prepared through 0.3 M of phosphoric acid. In addition, the upper images and the lower images of (a) to (c) of FIG. 13 show different magnifications.

As can be seen from (a) to (c) of FIG. 13, it was confirmed that the anodic aluminum oxides prepared through sulfuric acid and phosphoric acid have relatively low pore uniformity, whereas the anodic aluminum oxide prepared through oxalic acid has relatively high pore uniformity.

FIG. 14 is a view for explaining an influence according to a concentration of a pore-widening solution during the preparation process of the anodic aluminum oxide according to the experimental example of the present invention.

Referring to FIG. 14, it shows an SEM image for each of the anodic aluminum oxides after preparing the anodic aluminum oxides prepared through pore-widening solutions (phosphoric acid solutions) having different concentrations. In addition, a pore diameter for each of the anodic aluminum oxides was measured.

Specifically, (a) of FIG. 14 is an SEM image for upper pores of the anodic aluminum oxide. A diameter of the upper pores was measured to be 81 nm.
(b) of FIG. 14 is an SEM image for lower pores of the anodic aluminum oxide prepared through a pore-widening solution (phosphoric acid solution) having a concentration of 5 wt %. It was confirmed that the anodic aluminum oxide prepared through the pore-widening solution (phosphoric acid solution) having a concentration of 5 wt % has the lower pores that are not properly widened.
(c) of FIG. 14 is an SEM image for lower pores of the anodic aluminum oxide prepared through a pore-widening solution (phosphoric acid solution) having a concentration of 10 wt %. A diameter of the lower pores of the anodic aluminum oxide prepared through the pore-widening solution (phosphoric acid solution) having a concentration of 10 wt % was measured to be 85±5.82 nm.
(d) of FIG. 14 is an SEM image for lower pores of the anodic aluminum oxide prepared through a pore-widening solution (phosphoric acid solution) having a concentration of 15 wt %. A diameter of the lower pores of the anodic aluminum oxide prepared through the pore-widening solution (phosphoric acid solution) having a concentration of 15 wt % was measured to be 101±8.14 nm.

The measurement results of the diameter of the upper and lower pores are summarized through the following <Table 3>.

TABLE 3

| | Upper pore | Lower pore |
|---|---|---|
| Classification | diameter | diameter |
| 5 wt % of phosphoric acid | 81 nm | Uniform pore widening × |
| solution | | |
| 10 wt % of phosphoric acid | 81 nm | 85 ± 5.82 nm |
| solution | | |
| 15 wt % of phosphoric acid | 81 nm | 101 ± 8.14 nm |
| solution | | |

As can be seen from <Table 3>, it was confirmed that in a case of the anodic aluminum oxide prepared through the pore-widening solution (phosphoric acid solution) having a concentration of 10 wt %, a difference in diameter between the upper pores and the lower pores is significantly reduced.

As a result, it was found that the concentration of the pore-widening solution (phosphoric acid solution) needs to be controlled to be greater than 5 wt % and less than 15 wt % in order to form the upper pores and the lower pores that have the same diameter.

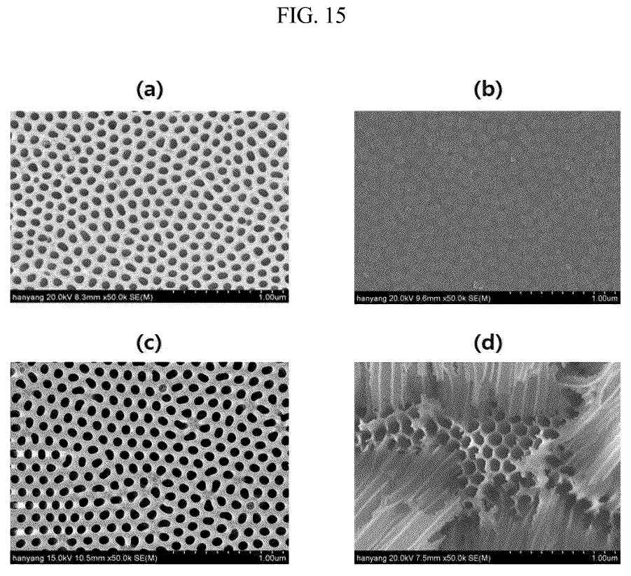

FIG. 15 is a view for explaining an influence according to a temperature of the pore-widening solution during the preparation process of the anodic aluminum oxide according to the experimental example of the present invention.

Referring to FIG. 15, it shows an SEM image for each of the anodic aluminum oxides after preparing the anodic aluminum oxides prepared through pore-widening solutions (phosphoric acid solutions) having different temperatures. Specifically, (a) of FIG. 15 is an SEM image for upper pores of the anodic aluminum oxide, (b) of FIG. 15 is an SEM image for lower pores of the anodic aluminum oxide prepared through a pore-widening solution (phosphoric acid solution) at a temperature of 25° C., (c) of FIG. 15 is an SEM image for lower pores of the anodic aluminum oxide prepared through a pore-widening solution (phosphoric acid solution) at a temperature of 33° C., and (d) of FIG. 15 is an SEM image for lower pores of the anodic aluminum oxide prepared through a pore-widening solution (phosphoric acid solution) at a temperature of 40° C.

As can be seen from (b) of FIG. 15, it was confirmed that the lower pores of the anodic aluminum oxide prepared through a pore-widening solution (phosphoric acid solution) at a temperature of 25° C. are not widened. In addition, as can be seen from (d) of FIG. 15, it was confirmed that the lower pores of the anodic aluminum oxide prepared through a pore-widening solution (phosphoric acid solution) at a temperature of 40° C. has a structure that is collapsed due to excessive widening. Whereas, as can be seen from (c) of FIG. 15, it was confirmed that the lower pores of the anodic aluminum oxide prepared through a pore-widening solution (phosphoric acid solution) at a temperature of 33° C. are properly widened.

As a result, it was found that the temperature of the pore-widening solution (phosphoric acid solution) needs to be controlled to be higher than 25° C. and lower than 40° C. in order to form the upper pores and the lower pores that have the same diameter.

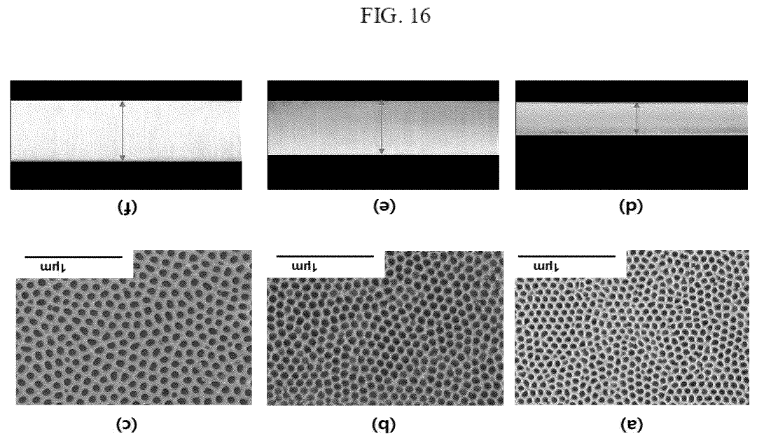

FIG. 16 is a view for explaining an influence according to an anodization voltage during the preparation process of the anodic aluminum oxide according to the experimental example of the present invention.

Referring to FIG. 16, it shows an image of upper pores and an image for measuring a thickness of the anodic aluminum oxides after preparing the anodic aluminum oxides prepared under different anodization voltage conditions.

Specifically, (a) of FIG. 16 shows an image of upper pores of the anodic aluminum oxide prepared under a voltage condition of 35 V, (b) of FIG. 16 shows an image of upper pores of the anodic aluminum oxide prepared under a voltage condition of 45 V, and (c) of FIG. 16 shows an image of upper pores of the anodic aluminum oxide prepared under a voltage condition of 55 V.

Specifically, (d) of FIG. 16 shows an image for measuring a thickness of the anodic aluminum oxide prepared under a voltage condition of 35 V, (e) of FIG. 16 shows an image for measuring a thickness of the anodic aluminum oxide prepared under a voltage condition of 45 V, and (f) of FIG. 16 shows an image for measuring a thickness of the anodic aluminum oxide prepared under a voltage condition of 55 V. The thicknesses of the pores measured through (d) to (f) of FIG. 16 are summarized through the following <Table 4>.

TABLE 4

| Classification | Thickness of anodic aluminum oxide |
|---|---|
| 35 V | 56.1 μm |
| 45 V | 96.8 μm |
| 55 V | 107.7 μm |

As can be seen from FIG. 16 and <Table 4>, it was confirmed that the anodic aluminum oxides prepared at 35 V and 45 V have a relatively thin thickness. When the thickness is thin, since handling is difficult, it was found that anodization needs to be performed at 55 V.

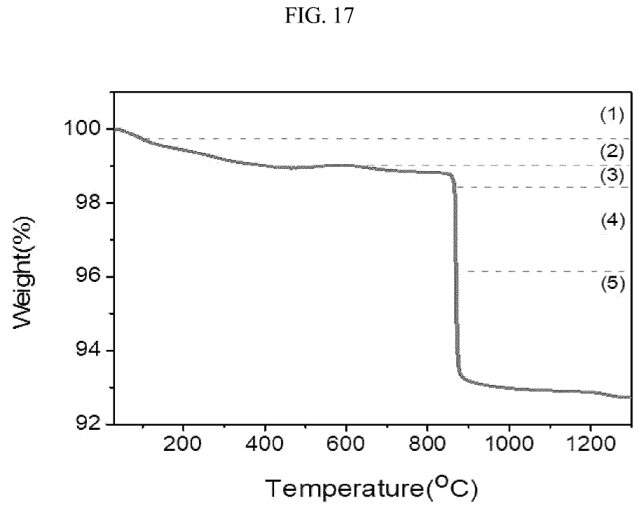

FIG. 17 is a view for explaining a change in weight according to a heat treatment temperature during the preparation process of the anodic aluminum oxide according to the experimental example of the present invention.

Referring to FIG. 17, it shows a change in weight (%) that is measured according to a heat treatment temperature during the preparation process of the anodic aluminum oxide according to the experimental example. As can be seen from FIG. 17, it was confirmed that as the heat treatment temperature is increased, the weight of the anodic aluminum oxide according to the experimental example is changed in five steps from (1) to (5). Specifically, it was confirmed that the weight is changed at a temperature of 100° C. or lower as moisture inside the anodic aluminum oxide was evaporated in step (1), the weight is changed at a temperature of 450° C. or lower due to dehydration of the anodic aluminum oxide in step (2), the weight is changed at a temperature of 850° C. or lower due to dehydration of the anodic aluminum oxide in step (3), the weight is changed at a temperature of 850° C. due to a primary phase change (amorphous-Al₂O₃->γ-Al₂O₃) of the anodic aluminum oxide in step (4), and the weight is changed at a temperature of 1300° C. due to a secondary phase change (γ-Al₂O₃->α-Al₂O₃) of the anodic aluminum oxide in step (5).

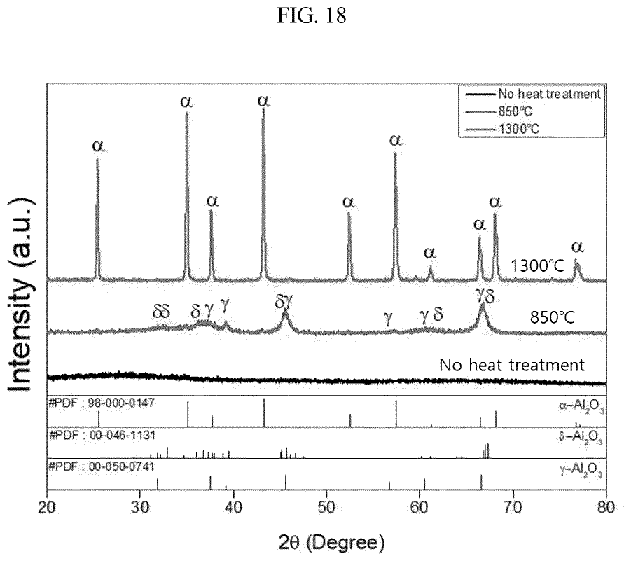

FIG. 18 is a view showing XRD analysis results for explaining a change in phase according to a heat treatment temperature during the preparation process of the anodic aluminum oxide according to the experimental example of the present invention.

Referring to FIG. 18, it shows results of X-ray diffraction (XRD) analysis of each of an anodic aluminum oxide before heat treatment (no heat treatment), an anodic aluminum oxide that has been heat-treated at a temperature of 850° C., and an anodic aluminum oxide that has been heat-treated at a temperature of 1300° C. after the anodic aluminum oxides are prepared.

As can be seen from FIG. 18, it was confirmed that the anodic aluminum oxide that has been heat-treated at a temperature of 850° C. has a γ-Al₂O₃ phase and a δ-Al₂O₃ phase, whereas the anodic aluminum oxide that has been heat-treated at a temperature of 1300° C. has an α-Al₂O₃ phase.

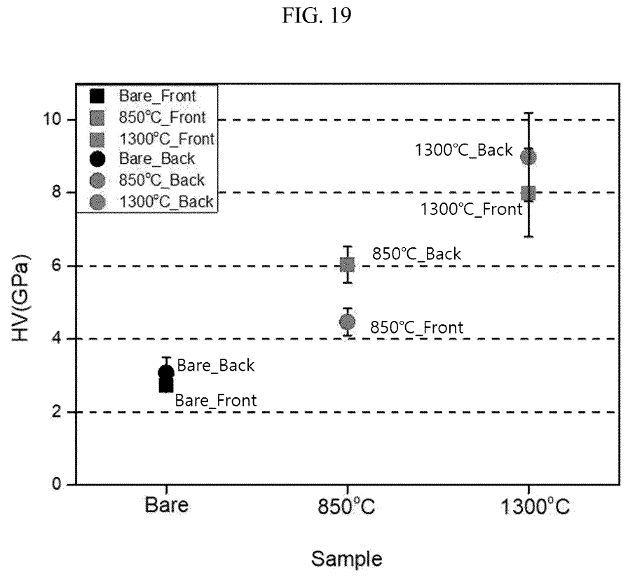

FIG. 19 is a view for explaining a change in Vickers hardness according to a heat treatment temperature during the preparation process of the anodic aluminum oxide according to the experimental example of the present invention.

Referring to FIG. 19, an anodic aluminum oxide (Bare) before heat treatment, an anodic aluminum oxide that has been heat-treated at a temperature of 850° C., and an anodic aluminum oxide that has been heat-treated at a temperature of 1300° C. are prepared, and then a Vickers hardness (HV, GPa) of an upper region (Front) and a lower region (Back) of each of the anodic aluminum oxides is measured and shown.

As can be seen from FIG. 19, it was confirmed that as the heat treatment temperature is increased, the Vickers hardness of the upper region and the lower region of the anodic aluminum oxide is increased.

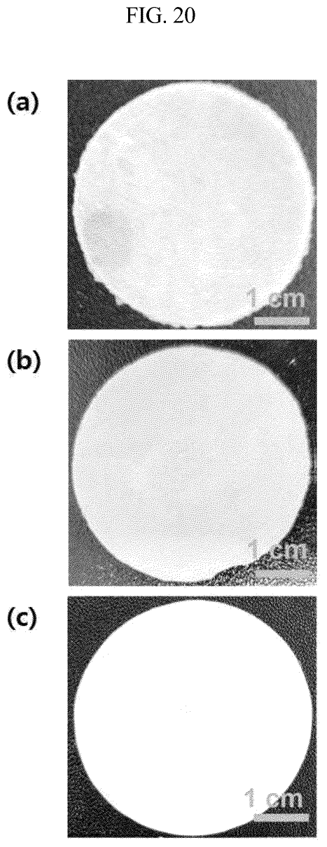

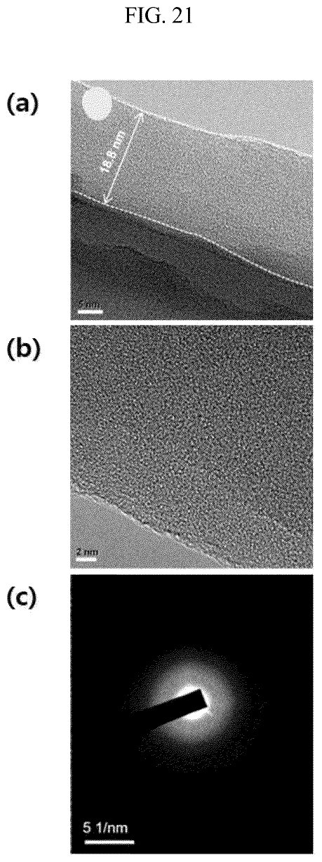

FIG. 20 is a view for explaining a change in state according to a heat treatment temperature during the preparation process of the anodic aluminum oxide according to the experimental example of the present invention.

Referring to (a) of FIG. 20, it shows a photograph of an anodic aluminum oxide before heat treatment, referring to (b) of FIG. 20, it shows a photograph of an anodic aluminum oxide that has been heat-treated at a temperature of 850° C., and referring to (c) of FIG. 20, it shows a photograph of an anodic aluminum oxide that has been heat-treated at a temperature of 1300° C.

As can be seen from FIG. 20, it was confirmed that an external change does not occur significantly despite the increase in the heat treatment temperature.

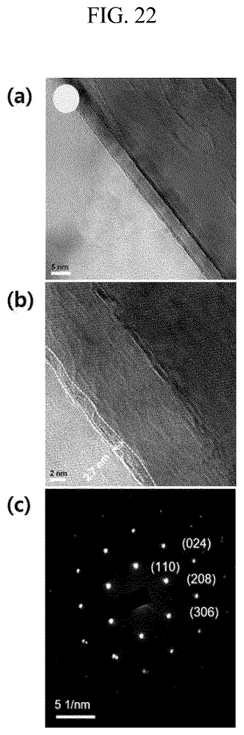

FIG. 22 is a view for explaining a change in contamination layer according to a heat treatment temperature during the preparation process of the anodic aluminum oxide according to the experimental example of the present invention.

Referring to FIG. 21, transmission electron microscope (TEM) images and a selected area electron diffraction (SAED) pattern image for the anodic aluminum oxide before heat treatment are shown. Specifically, (a) and (b) of FIG. 21 show TEM images having different magnifications, and (c) of FIG. 21 shows an SAED pattern image.

Referring to FIG. 22, it shows TEM images and an SAED pattern image for the anodic aluminum oxide that has been heat-treated at a temperature of 1300° C. Specifically, (a) and (b) of FIG. 22 show TEM images having different magnifications, and (c) of FIG. 22 shows an SAED pattern image.

As can be seen from FIGS. 21 and 22, it was confirmed that the anodic aluminum oxide before heat treatment has a contamination layer having a thickness of 18.8 nm, but the anodic aluminum oxide that has been heat-treated at a temperature of 1300° C. has a contamination layer having a reduced thickness of 2.7 nm.

While the present invention has been described in connection with the embodiments, it is not to be limited thereto but will be defined by the appended claims. In addition, it is to be understood that those skilled in the art can substitute, change, or modify the embodiments in various forms without departing from the scope and spirit of the present invention.

What is claimed is:

1. A preparation method for an anodic aluminum oxide, the preparation method comprising:
anodizing aluminum in an electrolyte including oxalic acid to prepare anodic aluminum oxide having upper pores;
applying a water-repellent coating to the upper pores of the anodic aluminum oxide;
etching a lower part of the anodic aluminum oxide having the upper pores to which the water-repellent coating has been applied to form lower pores;
immersing the anodic aluminum oxide in a pore-widening solution to widen a diameter of the lower pores such that the diameter of the lower pores is equal to a diameter of the upper pores; and
heat-treating the anodic aluminum oxide in which the upper pores and the lower pores have the same diameter.

2. The preparation method of claim 1, wherein as the anodic aluminum oxide is heat-treated, a phase of the anodic aluminum oxide is changed from amorphous Al₂O₃ to α-Al₂O₃.

3. The preparation method of claim 1, wherein a crack occurrence rate of the anodic aluminum oxide is reduced due to the same diameter of the upper pores and the lower pores during the heat treatment of the anodic aluminum oxide.

4. The preparation method of claim 1, wherein in the widening of the diameter of the lower pores,
the diameter of the upper pores is maintained by the water-repellent coating.

5. The preparation method of claim 1, wherein a concentration and a temperature of the pore-widening solution are controlled to reduce a difference in the diameter between the upper pores and the lower pores.

6. The preparation method of claim 5, wherein the concentration of the pore-widening solution is controlled to be greater than 5 wt % and less than 15 wt %, thereby reducing the difference in the diameter between the upper pores and the lower pores.

7. The preparation method of claim 5, wherein the temperature of the pore-widening solution is controlled to be higher than 25° C. and lower than 40° C., thereby reducing the difference in the diameter between the upper pores and the lower pores.

8. The preparation method of claim 1, wherein the anodic aluminum oxide is heat-treated at a temperature exceeding 850° C.

9. The preparation method of claim 1, wherein the pore-widening solution includes a phosphoric acid solution.

10. The preparation method of claim 1, wherein as the anodic aluminum oxide is heat-treated, a thermal conductivity and a hardness are improved, and a permittivity is reduced.

11. An anodic aluminum oxide having hollows for allowing upper pores and lower pores to communicate with each other,
wherein the anodic aluminum oxide includes the upper pores and the lower pores that have the same diameter, and has an α-Al₂O₃ phase.

12. The anodic aluminum oxide of claim 11, wherein the anodic aluminum oxide has a Vickers hardness of 800 GPa or greater.

13. The anodic aluminum oxide of claim 11, wherein the anodic aluminum oxide has a thermal conductivity of 13.7 W/m·K or greater.

14. The anodic aluminum oxide of claim 11, wherein the anodic aluminum oxide is applied to any one of a semiconductor probe card, a photonic structure, a sensor, a template, a membrane, a drug delivery substrate, and a composite functional layer.
